(19) United States
(12) Patent Application Publication
(10) Pub. No.: US 2022/0386262 A1
(43) Pub. Date: Dec. 1, 2022

(54) POSITIONING AND TIMING ADVANCE DETERMINATION

(71) Applicant: Telefonaktiebolaget LM Ericsson (publ), Stockholm (SE)

(72) Inventors: Olof LIBERG, ENSKEDE (SE); Mohammad MOZAFFARI, Fremont, CA (US); Johan LING, JÄRFÄLLA (SE)

(21) Appl. No.: 17/769,785

(22) PCT Filed: Oct. 15, 2020
(86) PCT No.: PCT/SE2020/050985

§ 371 Date: Apr. 18, 2022

Related U.S. Application Data
(60) Provisional application No. 62/916,923, filed on Oct. 18, 2019.

(51) Int. Cl. H04W 56/00; H04W 64/00

(52) U.S. Cl. CPC H04W 56/0045; H04W 64/00

(57) ABSTRACT

A method of operating a wireless device in a wireless communication network includes receiving a first reference signal at a first reception time from a first network node, receiving a second reference signal at a second reception time from a second network node, receiving a first indication of a first reference time, receiving a second indication of a second reference time, and transmitting a report to a serving network node. The indications of the first and second reference times indicate timings of frame structures of the first and second network nodes, respectively. The report is based on a first representation of a difference between the first reception time and the second reception time. The first representation is further based on the indications of the first and second reference times. Also provided are related devices and methods.

### TECHNICAL FIELD

This disclosure pertains to wireless communication technology, in particular regarding positioning and Timing Advance (TA) determination, for example in a time sensitive networking (TSN) network.

### BACKGROUND

In 3rd Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13, Narrowband Internet of Things (NB-IoT) and LTE for Machine Type Communication (LTE-M) are part of the LTE specifications and provide connectivity to massive Machine Type Communication (mMTC) services. These technologies have been further enhanced through all releases up until and including the ongoing Release 16 work.

In 3GPP Release 15, the first release of the 5G system (5GS) was specified. This is a new generation's radio access technology intended to serve use cases such as enhanced Mobile Broadband (eMBB), Ultra-Reliable and Low Latency Communication (URLLC) and mMTC. 5G includes the New Radio (NR) access stratum interface and the 5G Core Network (5GC). The NR physical and higher layers are reusing parts of the LTE specification, and to that add needed components when motivated by the new use cases. One such use case is critical MTC (cMTC). NR URLLC was introduced in 3GPP Release 15 for the support of cMTC and is further enhanced in Release 16 within the enhanced URLLC (eURLLC) and Industrial Internet of Things (IoT) work items. Also, LTE supports URLLC since Release 15.

3GPP has now started the preparations for Release 17 and are e.g. discussing potential solutions in the area of facilitating positioning for factory environments and efficient small data transmission. LTE and NR support positioning by means of Observed Time Difference of Arrival (OTDOA) in time aligned networks. However, most network deployments do not support time aligned transmissions across network nodes. For efficient small data transmission, latency is of importance. Existing solution for configuration of Timing Advance (TA), where a network node determines the TA based on a received random access preamble and signals the TA to a wireless device, introduces a relatively high signaling overhead and latency. Therefore, the existing TA solution may not be suited for efficient small data transmission.

### SUMMARY

As described above there currently exist certain challenges. Therefore, it is an object of at least some embodiments of the present disclosure to reduce the control signaling overhead and latency for determining and configuring the TA to support synchronized uplink transmissions. Further, it is also an object of at least some embodiments of the present disclosure to provide approaches to allow positioning of a wireless device regardless of whether the network nodes provide time aligned transmissions. This positioning may be used when determining and configuring the TA.

There is disclosed a method of operating a wireless device in a wireless communication network. The method may comprise receiving a first reference signal at a first reception time (or receive time) from a first network node, and receiving a second reference signal at a second reception time (or receive time) from a second network node. The method may comprise receiving a first indication of a first reference time associated with the first network node. The first indication of the first reference time may indicate a timing of a frame structure of the first network node. The method may comprise receiving a second indication of a second reference time associated with the second network node. The second indication of the second reference time may indicate a timing of a frame structure of the second network node. The method may comprise transmitting a report to a serving network node. The report may be based on a first representation of a difference between the first reception time and the second reception time. The first representation may be further based on the first indication of the first reference time and the second indication of the second reference time.

There is also disclosed another method of operating a wireless device in a wireless communication network. The method may comprise receiving a first reference signal at a first reception time from a first network node, and receiving a second reference signal at a second reception time from a second network node. The method may comprise receiving a first indication of a first reference time associated with the first network node. The first indication of the first reference time may indicate a timing of a frame structure of the first network node. The method may comprise receiving a second indication of a second reference time associated with the second network node. The second indication of the second reference time may indicate a timing of a frame structure of the second network node. The method may comprise transmitting communication signaling to a serving network node using a transmission offset. The transmission offset may be based on an indication of a distance between the serving network node and the wireless device. The indication of the distance between the serving network node and the wireless device may be based on an indication of a position of the serving network node and an indication of a position of the wireless device. The indication of the position of the wireless device may be based on a first representation of a difference between the first reception time and the second reception time. The first representation may be further based on the first indication of the first reference time and the second indication of the second reference time.

There is also disclosed another method of operating a wireless device in a wireless communication network. The method may comprise receiving a first reference signal at a first reception time from a first network node, and receiving a second reference signal at a second reception time from a second network node. The method may comprise receiving a first indication of a first reference time associated with the first network node. The first indication of the first reference time may indicate a timing of a frame structure of the first network node. The method may comprise receiving a second indication of a second reference time associated with the second network node. The second indication of the second reference time may indicate a timing of a frame structure of the second network node. The method may comprise determining an indication of a position of the wireless device. The indication of the position may be based on a first representation of a difference between the first reception time and the second reception time. The first representation may be further based on the first indication of the first reference time and the second indication of the second reference time.

There is also disclosed a method of operating a serving network node in a wireless communication network. The method may comprise configuring a wireless device to transmit a report. The report may be based on a first indication of a first reference time and a second indication of a second reference time. The first indication of the first reference time may be associated with a first network node. The first indication of the first reference time may indicate a timing of a frame structure of the first network node. The second indication of the second reference time may be associated with a second network node. The second indication of the second reference time may indicate a timing of a frame structure of the second network node. The method may comprise receiving the report from the wireless device. The report may be based on a first representation of a difference between a first reception time and a second reception time. The first reception time may be associated with a first reference signal transmitted by the first network node to the wireless device. The second reception time may be associated with a second reference signal transmitted by the second network node to the wireless device. The first representation may be further based on the first indication of the first reference time and the second indication of the second reference time.

There is also disclosed a method of operating a positioning network node in a wireless communication network. The method may comprise receiving a first representation of a difference between a first reception time and a second reception time. The first reception time may be associated with a first reference signal transmitted by a first network node to a wireless device. The second reception time may be associated with a second reference signal transmitted by a second network node to the wireless device. The method may comprise determining a first compensated representation of the difference. The first compensated representation may be based on the first representation, a first indication of a first reference time associated with the first network node, and a second indication of a second reference time associated with the second network node. The first indication of the first reference time may indicate a timing of a frame structure of the first network node. The second indication of the second reference time may indicate a timing of a frame structure of the second network node.

There is disclosed a wireless device configured for operation in a radio access network. The wireless device may be configured to perform any of the methods of operating the wireless device described above. The wireless device may be implemented as a user equipment or a terminal. The wireless device may comprise, and/or be adapted to utilize, processing circuitry and/or radio front-end circuitry, in particular a transceiver and/or transmitter and/or receiver, for receiving the reference signals and transmitting the report and/or signaling.

There is disclosed a network node configured for operation in a radio access network. The network node may be configured to perform any of the methods of operating the positioning network node and/or the serving network node described above. The network node may comprise, and/or be adapted to utilize, processing circuitry and/or radio front-end circuitry, in particular a transceiver and/or transmitter and/or receiver, for communicating, in particular for receiving the report and/or receiving the first representation. The network node may be a serving network node. The network node may be a positioning network node.

Certain embodiments may provide a reduction of control signaling overhead for determining and configuring a transmission offset (such as a TA) in order to support synchronized uplink transmissions. Also, certain embodiments may enable positioning of a wireless device in a wireless communication network even if the network nodes may not provide time aligned transmissions. This positioning may be used when determining and configuring the transmission offset.

Generally, all terms used are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention may best be understood by referring to the following description and accompanying drawings that are used to illustrate particular embodiments of the invention. In the drawings:

FIG. 1 illustrates the Observed Time Difference of Arrival (OTDOA) positioning.

FIG. 2 is a flowchart illustrating a method of operating a wireless device according to one embodiment.

FIG. 3 is a flowchart illustrating a method of operating a wireless device according to one embodiment.

FIG. 4 is a flowchart illustrating a method of operating a serving network node according to one embodiment.

FIG. 5 is a flowchart illustrating a method of operating a positioning network node according to one embodiment.

FIG. 6 illustrates a wireless network in accordance with some embodiments.

FIG. 7 illustrates a user equipment in accordance with some embodiments.

FIG. 8 illustrates a telecommunication network connected via an intermediate network to a host computer in accordance with some embodiments.

FIG. 9 illustrates a host computer communicating via a base station with a user equipment over a partially wireless connection in accordance with some embodiments.

FIGS. 10-13 are flowcharts illustrating methods implemented in a communication system including a host computer, a base station and a user equipment in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In the following, concepts and approaches are described in the context of NR technology. However, the concepts and approaches may be applied to other radio access technologies (RATs). Moreover, the concepts and approaches are discussed in the context of communication between network nodes (e.g. gNBs or Base Stations (BS)) and a wireless device (e.g. UE), for downlink and uplink subject transmission but may also be applied to a sidelink scenario, in which the involved network nodes may be wireless devices.

The next paradigm shift in processing and manufacturing is the Industry 4.0 in which factories are automated and made much more flexible and dynamic with the help of wireless connectivity. This includes real-time control of robots and machines using time critical MTC (cMTC). It also includes improved observability, control, and error detection with the help of large numbers of more simple actuators and sensors that can be said to belong to the category of mMTC.

Time Sensitive Networking (TSN) is one of the essential features for supporting Industry 4.0. It supports the signaling of an accurate reference time indication from a gNB, e.g. a base station (BS), to a UE. The delivery of the reference time indications may be provided using e.g. broadcast (e.g. one of the system information blocks) or unicast Radio Resource Control (RRC) signaling. The granularity of the indicated reference time may be at most 50 ns. It is worth noting that a similar feature is introduced in Release 15 LTE providing 0.25 us granularity. The reference time indication may e.g. be delivered using SIB-16 or a dedicated RRC message.

A UE performs a random access procedure for achieving uplink transmission timing synchronization. The uplink transmission timing synchronization is achieved by the UE applying a timing advance (TA), such as a transmission timing offset, to its uplink frame structure, relative the downlink frame structure. The magnitude of the TA is equivalent to the round-trip time (RTT) between the UE and the BS. This procedure may be done before establishing a connection.

In the conventional random access procedure, the BS determines the TA from the reception timing of the Physical Random Access Channel (PRACH) preamble, relative the start of the configured PRACH time-frequency resource, and signals the TA to the UE in the Random Access Response (RAR) message. The UE may apply the TA transmission timing offset to subsequent transmissions.

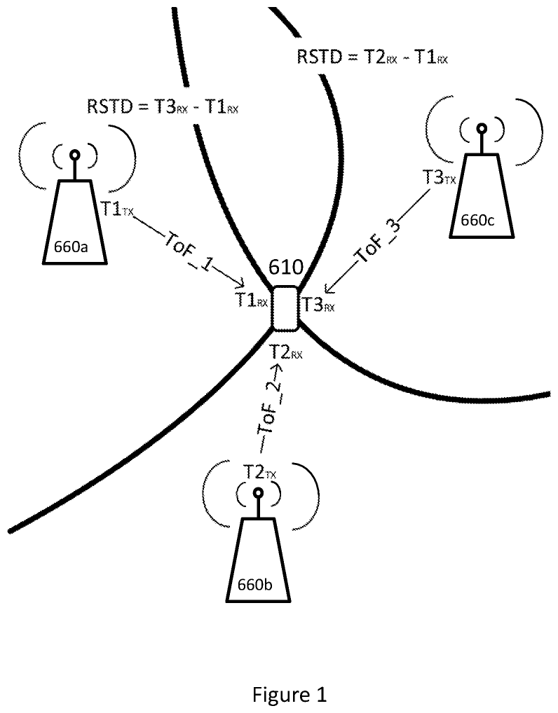

FIG. 1 illustrates the Observed Time Difference of Arrival (OTDOA) positioning method, which was introduced for LTE in 3GPP Release 9. The UE (610) receives a first reference signal at a first reception time (T1Rx), where the first reference signal is transmitted at a first reference signal transmission time (T1Tx) from a first network node (660a). Further, the UE (610) receives a second reference signal at a second reception time (T2Rx), where the second reference signal is transmitted at a second reference signal transmission time (T2Tx) from a second network node (660b). Also, the UE (610) receives a third reference signal at a third reception time (T3_{RX}), where the third reference signal is transmitted at a third reference signal transmission time (T3_{TX}) from a third network node (660c). The difference between the reference signal transmission time and the reception time corresponds to the Time of Flight (TOF) between the network nodes and the UE (ToF_1, ToF_2, ToF_3).

OTDOA is based on the UE (610) measuring the reception times (T1_{RX}, T2_{RX}, T3_{RX}), e.g. the time of arrival (TOA), of reference signals received from at least three cells or gNBs (660a, 660b, 660c). The UE (610) calculates the difference in reception time between the reference signals received from the three cells. This difference is known as the received reference signal time difference (RSTD). In a time synchronized network with time aligned reference signal transmission timing, the RSTD may be equivalent to the difference in time-of- arrival (TOA) between the reference signals.

If it is assumed that the gNBs transmissions are time aligned, the reference signal transmission timing could be aligned, meaning that the reference signal transmissions time would be the same in the three nodes (T1_{TX}=T2_{TX}=T3_{TX}). In this case the RSTD for two cells (e.g. 1 and 2) can simply be calculated as:

RSTD₁₋₂=T2_{RX}−T1_{RX}=(T2_{TX}+ToF_2)−(T1_{TX}+ToF_1)=ToF_2−ToF_1 (Eq. 1)

where TN_{TX}corresponds to the reference signal transmission time of gNB N, TN_{RX}corresponds to the UE reception time of the corresponding reference signal transmitted from gNB N, and ToF N corresponds to the Time of Flight (ToF) of the reference signal between the UE and gNB N, and where it is assumed that T1_{TX}=T2_{TX}.

In the same way, the RSTD for the second and third network node could be calculated as RSTD₂₋₃=ToF_3−ToF_2. Further, the RSTD for the first and third network node could be calculated as RSTD₁₋₃=ToF_3−ToF_1.

Every such RSTD, derived for a pair of cells, determines a geographical hyperbola. The UE's position can be determined at the intersection point of these hyperbolas as illustrated in FIG. 1.

NR was introduced in 3GPP Release 15 and focused mainly on enhanced mobile broadband (eMBB) and cMTC. For Release 17, however, a NR UE type with lower capabilities may be introduced. The intention is to support an MTC version of NR. NR-Light was the working name in the Rel-17 RAN preparations (and it is now referred to as NR-Redcap in the work on Rel-17 RAN). NR-light is intended as a mid-end system, filling the gap between eMBB NR and NB-IoT/LTE-M, e.g. to provide more efficient inband operation with URLLC in industrial use cases.

Related to NR Light, Release 17 discussions have also started on Small Data Enhancements. That is, techniques to optimize transmission of small data payloads. Solutions such as Early Data Transmission (EDT), specified for NB-IoT and LTE-M for mobile originated access in Release 15, and mobile terminated access in Rel-16, 2-step RACH, grant-free transmission, Preconfigured Uplink Resources (specified in Release 16 for LTE-M and NB-IoT), Non-Orthogonal Multiple Access (NOMA) are considered.

Some of these solutions considered for small data transmission require a valid TA before the initial transmission. In the current LTE and NR systems, the support for having a valid TA before initial transmission is limited to stationary UEs and UEs camping on small cells. This obviously excludes many of the UEs in the LTE and NR network that are mobile and are camping on macro cells.

The Release 17 discussions also target NR positioning enhancements targeting use cases such as factory and campus positioning. In industrial environments it can be expected that the TSN feature will be supported in the deployed networks.

LTE and NR support UE positioning by means of OTDOA in time aligned networks. Most network deployments, however, do not support time aligned transmissions across gNBs. In the more general case of a network of gNBs not being time aligned, the reference signal transmissions time may not be the same in the nodes (e.g. T1_{TX}≠T2_{TX}). Then, the RSTD computation will be biased by the difference in the reference signal transmission times (T2_{TX}−T1_{TX}) and therefore is unsuited for OTDOA positioning:

RSTD₁₋₂=T2_{RX}−T1_{RX}=(T2_{TX}+ToF_2)−(T1_{TX}+ToF_1)=(ToF_2−ToF_1)+(T2_{TX}−T1_{TX}) (Eq. 2)

Certain example embodiments may enable a UE to autonomously determine its position based on OTDOA supported by a reference time indication. Furthermore, the UE may use an indication of the position for determining its TA, e.g. before accessing the network.

In a first example a UE may determine a compensated RSTD' for a reference signal or channel transmitted from two cells based on Eq. 2, but compensating for the bias introduced by the non-alignment of the transmission time of the reference signals. The UE can use the reference time indication (e.g. TN′_{TX}) broadcasted by each cell N to correct the biased RSTD estimate introduced in Eq. 2. We here exemplify the principle for two cells 1 and 2:

RSTD₁₋₂′=RSTD₁₋₂−(T2′_{TX}−T1_{TX})=T2_{RX}−T1_{RX}−(T2′_{TX}−T1_{TX})=(ToF_2−ToF_1)+(T2_{TX}−T1_{TX})−(T2′_{TX}−T1_{TX})=(ToF_2−ToF_1) (Eq. 3)

It is assumed that even though the reference signal transmission time may not be the same as the reference time indicated by the reference time indication (e.g. if T1_{TX}≠T1′_{TX}), the difference between the first and second reference time and the difference between the transmit time of the first and second reference signal would be the same, such that (T2_{TX}−T1_{TX})=(T2′_{TX}−T1′_{TX}).

In another example a gNB may determine the compensated RSTD' based on a reported RSTD sent from the UE. The gNB may use reference time indications, which may be shared between the cells, to correct the biased RSTD estimate introduced in Eq. 2. The gNB may already have access to its own reference time indication (e.g. T1′_{TX}) and/or the reference signal transmission time (e.g. T1_{TX}) and therefore only requires the reference time indication or the reference signal transmission time of the other gNBs. The reference time indication and/or reference signal transmission time of the other gNBs may be received from the wireless device or from the other gNBs or from another network node. Using Eq. 3, the network node may derive the compensated RSTD' based on the received RSTD and the reference time indication.

In another example the UE may estimate the RSTD' for three or more cells. Based on a signaled position indication of each gNB and the RSTD's, the UE can use conventional multilateration methods to determine the RSTD' hyperbolas based on which it can estimate its geographical position to the point of intersection between the hyperbolas as shown in FIG. 1.

In another example the reference signal may be one of a Cell Reference Signal (CRS), a Synchronization Signal Block (SSB), a Channel State Information Reference Signal (CSI-RS), a Tracking Reference Signal (TRS), a Phase Tracking Reference Signal (PTRS), a Positioning Reference Signal (PRS) or a Physical Downlink Shared Channel (PDSCH) carrying a system information message.

In another example the gNB's position indication and/or the reference time indication may be broadcasted in a system information message or block. It may also be conveyed using dedicated signaling using the RRC protocol layer or Non-Access Stratum (NAS) protocol layer.

In another example the UE may be configured to position itself and signal the indication of its position to a network node.

In another example the UE signals an indication of the measured RSTD' to the network, and the network determines the position of the UE.

In another example the UE signals an indication of the measured RSTD to the network, and the network calculates the RSTD' based on reference time indications of the network nodes. Based on at least three RSTD's, the network may determine the position of the UE. The position may be determined by a serving gNB or a positioning node connected to the gNB.

In another example, which may be based on the above methods, each of the gNBs may broadcast an indication of their reference time and may also broadcast an indication of its geographical position.

In another example the UE calculates the TA based on its own position, an indication of the gNB's position and the speed of light C as:

TA=2·(D_{UE-BS}/C) (Eq. 4)

where DUE-BS is an indication of distance between the UE and the gNB. This method can be applied on top of any positioning solution that allows the UE to determine the distance to the serving BS.

In another example the UE uses the TA when accessing the network e.g. for the purpose of the random access procedure or for the purpose of small data transmission.

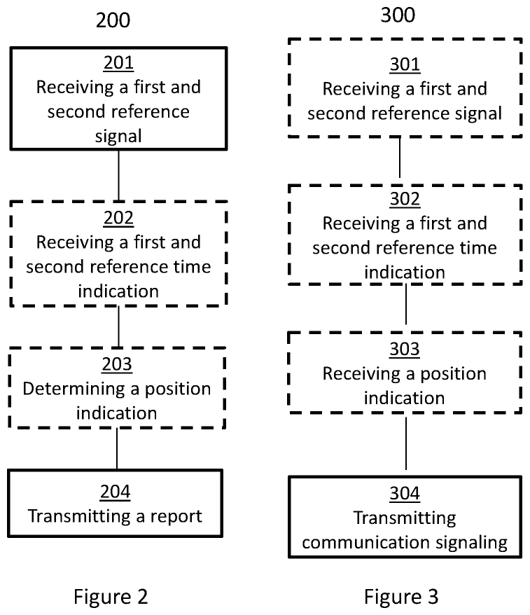

FIG. 2 is a flowchart illustrating a method (200) of operating a wireless device in a wireless communication system, in accordance with one embodiment. The method (200) may comprise receiving (201) a first reference signal at a first reception time (which may for example also be referred to as a first receive time) from a first network node, receiving (201) a second reference signal at a second reception time (which may for example also be referred to as a second receive time) from a second network node, and transmitting (204) a report to a serving network node. The report may be based on a first representation of a difference between the first reception time and the second reception time. The first representation may further be based on a first indication of a first reference time associated with the first network node. The first reference time may for example be associated transmissions by the first network node.

The reference signal may be one or more of a Cell Reference Signal (CRS), a Synchronization Signal Block (SSB), a Channel State Information Reference Signal (CSI-RS), a Tracking Reference Signal (TRS), a Phase Tracking Reference Signal (PTRS), a Positioning Reference Signal (PRS) or a Physical Downlink Shared Channel (PDSCH) carrying a system information message. It may be considered that the transmission characteristics (e.g. signal strength and/or form and/or modulation and/or timing) of the reference signal may be available to the wireless device. The reference signal may be transmitted using one or more time and/or frequency resources, which may or may not be consecutive in time and/or frequency. The reference signal may be broadcasted or unicasted and may be transmitted periodically or upon request from the wireless device. The reference signal may be adapted for estimating or representing channel conditions, e.g. channel conditions and/or transmission path conditions and/or channel (or signal or transmission) quality.

The first reception time (e.g. T1_{RX}) may correspond to the point in time where the first reference signal is received by the wireless device. The second reception time (e.g. T2_{TX}) may correspond to the point in time where the second reference signal is received by the wireless device. The first and second reception time may correspond to the estimated TOA of the respective first and second reference signals. The first representation of the difference between the first and second reception time may relate to the difference between the first and second TOA of the respective first and second reference signals at the wireless device. The first representation of the difference may relate to the difference between the first and second reception times such as by subtracting one from the other (e.g. T2_{RX}−T1_{RX}). The first representation of the difference may relate to the RSTD. The first representation of the difference may relate to one of the reception times, and an offset (e.g. T1_{RX}, (T2_{RX}−T1_{RX})). The first representation may relate to the absolute values of the reception times (e.g. T1_{RX}, T2_{RX}), where the difference could e.g. be derived based on the absolute values of the reception times.

The first indication of the first reference time (e.g. T1_{TX}) may be received (202) from the first network node in a system information message. The first indication of the first reference time may indicate a timing of a frame structure of the first network node. The first indication of the first reference time may indicate the transmission time (T1_{TX}) of the first reference signal (e.g. T1_{TX}=T1′_{TX}). The first indication of the first reference time may correspond to the first reference time indication. The system information message may be transmitted as, or comprise, a system information block (SIB). The system information message may be broadcasted. The system information message may be, or comprise, a system information block (SIB) such as SIB-16 or any other SIB. The first indication of the first reference time may be unicasted, e.g. using the RRC protocol layer, NAS protocol layer, Medium Access Control (MAC) protocol layer, or a Downlink Control Indication (DCI), including e.g. an RRC message, a NAS message, a MAC control element (CE) or a dedicated RRC message. The granularity of the first indication of the first reference time may be e.g. 50 ns or 0.25 us, but it may also have a granularity of e.g. 10 ns, 100 ns, 200 ns etc. The granularity may refer to the level of detail of which the first indication of the first reference time is defined. The first indication of the first reference time may be received from the first network node, or from another network node different from the first network node. The first indication of the first reference time associated with the first network node may correspond to that the first indication of the first reference time indicates the reference time of the first network node. The first indication of the first reference time may indicate the timing of a frame structure of the first network node regardless of whether it is received in the system information message or not.

The first representation may further be based on a second representation of a difference between the first indication of the first reference time (e.g. T1′_{TX}) and a second indication of a second reference time (e.g. T2′_{TX}) associated with a second network node. The second representation may correspond to the difference between the indication of the reference times such as by subtracting one from the other (e.g. T2′_{TX}−T1′_{TX}). The second representation may also be represented by the absolute values of the indication of the reference times (e.g. T1′_{TX}, T2′_{TX}) where the difference could, e.g., be derived based on the absolute values of the indication of the reference times. The first representation of the difference may correspond to the compensated RSTD' according to Eq. 3 above. The first representation of the difference may correspond to the difference between the first and second receive time, compensated by the difference between the first indication of the first reference time and the second indication of the second reference time (e.g. T2_{RX}−T1_{RX}−(T2′_{TX}−T1′_{TX}) or RSTD−T2′_{TX}−T1_{TX}). The first representation may correspond to the difference between the first and second reception time and additionally the difference of the first and second indication of the first and second reference time, e.g. the RSTD and (T2′_{TX}−T1_{TX}). The first representation of the difference may correspond to the difference between the first and second reception time and additionally one or both of the indications of reference times, e.g. RSTD and (T2′_{TX} and/or T1′_{TX}). The first representation may correspond to both the reception times and one or both of the indications of reference times, e.g. T1_{RX}, T2_{RX}, (T1′_{TX} and/or T2′_{TX}). The first representation may correspond to both reception times and the difference between the first and second indication of the first and second reference time, e.g. T1_{RX}, T2_{TX}, (T2′_{TX}−T1′_{TX}). The first indication of the first reference time may correspond to the first reference signal transmission time (e.g. T1_{TX}=T1′_{TX}). The second indication of the second reference time may correspond to the second reference signal transmission time (e.g. T2_{TX}=T2′_{TX}). The first indication of the first reference time may relate to the first reference signal transmission time as the second indication of the second reference time may relate to the second reference signal transmission time (e.g. T1_{TX}≠T1′_{TX}, T2_{TX}≠T2′_{TX}, and (T2_{TX}−T1_{TX})=(T2′_{TX}−T1′_{TX})).

The second indication of the second reference time may be associated with the second network node. The second reference time may for example be associated transmissions by the second network node. The second indication of the second reference time (e.g. T2′_{TX}) may be received (202) from the second network node in a system information message. The second indication of the second reference time may indicate a timing of a frame structure of the second network node. The second indication of the second reference time may indicate the transmission time (e.g. T2_{TX}) of the second reference signal (e.g. T2_{TX}=T2′_{TX}). The second indication of the second reference time may correspond to the second reference time indication. The system information message may be transmitted as, or comprise, a system information block (SIB). The system information message may be broadcasted. The system information message may be, or comprise, a system information block (SIB) such as SIB-16 or any other SIB. The second indication of the second reference time may be unicasted, e.g. using the RRC protocol layer, NAS protocol layer, Medium Access Control (MAC) protocol layer, or a Downlink Control Indication (DCI), including e.g. an RRC message, a NAS message, a MAC control element (CE) or a dedicated RRC message. The granularity of the second indication of the second reference time may be e.g. 50 ns or 0.25 us, but it may also have a granularity of e.g. 10 ns, 100 ns, 200 ns etc. The second indication of the second reference time may be received from the second network node, or from another network node different from the second network node. The second indication of the second reference time associated with the second network node may correspond to that the second indication of the second reference time indicates the reference time of the second network node. The second indication of the second reference time may indicate the timing of a frame structure of the second network node regardless of whether it is received in the system information message or not. The granularity may refer to the level of detail of which the second indication of the second reference time is defined. The second indication of the second reference time may be received from the second network node, or from another network node different from the second network node. The second indication of the second reference time associated with the second network node may correspond to that the second indication of the second reference time indicates the reference time of the second network node. The second indication of the second reference time may indicate the timing of a frame structure of the second network node regardless of whether it is received in the system information message or not.

The first indication of the first reference time may be received from the first network node and the second indication of the second reference time may be received from the second network node. The first indication of the first reference time may be received from another network node such as e.g. the serving network node or the second network node or another network node. The second indication of the second reference time may be received from another network node such as e.g. the serving network node or the first network node or another network node.

The first indication of the first reference time may indicate a timing of a frame structure of the associated first network node. The second indication of the second reference time may indicate a timing of a frame structure of the associated second network node. A network node may have a frame structure, where a frame in the frame structure usually has at least a starting time point and a time duration. The frame structure may comprise a set of frames which may be consecutive in time. The frame structure may comprise subframes, radio frames, system frames, and/or hyper frames having different time durations. The indication of the reference time may e.g. indicate a time at the ending boundary of one of the frames, e.g. the time where the network node has just finished transmitting the frame. The indication of the reference time may indicate a starting time of the frame, or a time related to a specific transmission within the frame, e.g. a reference signal transmission time. The frame may be a reference frame having a reference frame number. The reference frame number may be indicated to the wireless device e.g. together with the indication of the reference time or separately. Each frame may have a corresponding reference time or one reference time may be used for a plurality of frames.

The indication of the reference time may be represented by one or more of a number of days, a number of hours, a number of minutes, a number of seconds, a number of milliseconds, a number of microseconds, a number of nanoseconds or any fraction of the numbers such as e.g. a half, a quarter, etc. The indication of the reference time may have a related origin. The indication of the reference time may be defined by the number of days, hours, minutes etc. which has passed since its related origin. The origin of the indication of the reference time may be 00:00:00 on the Gregorian calendar date 6 Jan. 1980 (such as the start of Global Positioning System (GPS) time). The origin of the indication of the reference time may be unspecified. The origin may be defined as a starting time where the indication of the reference time is zero.

The first and second indication of the first and second reference time may have the same origin, e.g. by using the same reference clock. The reference clock may be based on Global Navigation Satellite System (GNSS) signals (e.g. GPS, Galileo, or Globalnaya Navigatsionnaya Sputnikovaya Sistema (Glonass)), a network clock, synchronization signaling between network nodes, etc. The first and second indication of the first and second reference time may be equal (e.g. T1′_{TX}=T2′_{TX}), which may indicate that the first and second network node are time or frame aligned. The first and second indication of the first and second reference time may be different (e.g. T1′_{TX}≠T2′_{TX}) which may indicate that the first and second network node are not time or frame aligned. Frame alignment or time alignment may mean that the starting time of a frame of the first network node coincides with the starting time of a frame of the second network node. Frame alignment or time alignment may mean that a reference signal transmission time of the first network node coincides with a reference signal transmission time of the second network node. Coincide may in this case relate to taking place at the same point in time. Coincide may in this case relate to taking place at two points in time with only a small offset in time. One frame of the first network node may have the same or a different frame number compared to the frame number of a frame of the second network node even if the frames may at least partially overlap in time or may be time aligned. The first and second indication of the first and second reference time may or may not indicate the same reference point in the frame structure.

The report may include the first representation. The report including the first representation may be transmitted to the serving network node. The report including the first representation may be transmitted to further network nodes. The report including the first representation may be forwarded to further network nodes by the serving network node. The report may include the RSTD'. The report may include the RSTD.

The method (200) may further involve determining (203) an indication of a position of the wireless device, wherein the indication of the position is determined based on the first representation. To determine the indication of the position, the wireless device may receive a third reference signal at a third reception time (T3_{RX}) from a third network node. The wireless device may further use a third indication of a third reference time (T3′_{TX} or T3_{TX}) associated with the third network node. The wireless device may determine the indication of the position based on the first representation and further a second representation of a difference between the first reception time and the third reception time, and a third representation of a difference between the second reception time and the third reception time. The second and third representations may be derived in the same way as described above with relation to the first representation. The second and third representations may correspond to RSTD'₁₋₃ and RSTD'₂₋₃. The wireless device may determine further representations (e.g. RSTD's) in the same way as described above using further network nodes. The wireless device may use the further representations to determine the indication of the position.

The wireless device may use the first representation together with at least the second and third representation to determine the indication of the position of the wireless device. The indication of the position may be determined using triangulation, multilateration, and/or a geographic hyperbola. The indication of the position may be determined using OTDOA positioning by using the compensated RSTD' instead of the RSTD. The indication of the position may indicate the position of the wireless device such as the geographical position (e.g. represented by coordinates in a coordinate system). The indication of the position may indicate a relative position, e.g. relative to one or more network node. The wireless device may determine the indication of its position based on indications of positions of the first, second, third, and/or further network nodes. The indication of the position of a network node may indicate the position of the network node such as the geographical position (e.g. represented by coordinates in a coordinate system). The indications of the positions of the first, second, third, and/or further network nodes may be received by the wireless device or preconfigured in the wireless device.

The indications of the positions of the first, second, third, and/or further network nodes may be broadcasted. The indication of the position of the first network node may be transmitted from the first network node, or another network node, e.g. using broadcasting or unicasting. The wireless device may use the determined indication of the position to estimate a transmission offset used for transmission to the serving network node. The transmission offset may correspond to the TA.

The report may include the indication of the position of the wireless device. The report may include both the indication of the position and the first representation. The report may include either the indication of the position or the first representation. The report may also include other representations, such as e.g. the second, third, or further representations. The report may be transmitted to the serving network node using e.g. an uplink control message or an uplink data message. The report may be transmitted periodically or requested by the serving network node.

The wireless device may report the first (and/or further) representation to the serving network node. The wireless device may receive the indication of the position of the wireless device from the serving network node or another network node, e.g. based on the reported first representation. The wireless device may use the received indication of the position to estimate a transmission offset used for transmission to the serving network node. The transmission offset may correspond to the TA.

The wireless device may receive a configuration from the serving network node, the configuration configuring the wireless device that the report should be based on at least the first indication of the first reference time. The wireless device may transmit capability information to the serving network node, said capability information indicating to the serving network node that the wireless device is capable of using the at least the first indication of the first reference time when reporting based on the at least first representation. The wireless device may receive the configuration in response to transmitting the capability information.

The serving network node may be the first network node, the second network node, the third network node or another network node. The network nodes may be part of the same or different radio access technologies (RATs). The network nodes may be collocated at the same geographical position or located at different geographical positions compared to each other.

FIG. 3 is a flowchart illustrating a method (300) of operating a wireless device in a wireless communication system. The method (300) may comprise transmitting (304) communication signaling to a serving network node using a transmission offset. The transmission offset may be based on an indication of a distance between the serving network node and the wireless device. The transmission offset may be an offset of an uplink frame structure and a downlink frame structure. The downlink frame structure and the uplink frame structure may be the downlink frame structure and the uplink frame structure of the serving network node. The transmission offset may be a timing offset of the uplink frame structure and the downlink frame structure. The transmission offset may be an offset of an uplink transmission relative to a downlink transmission. The transmission offset may be used to ensure that the downlink and uplink are synchronized at the serving network node. The transmission offset may be a transmission timing offset. The transmission offset may represent a timing relation, e.g. a timing offset. A downlink transmission corresponds to a transmission from a network node to one or more wireless devices, while an uplink transmission corresponds to a transmission from a wireless device to one or more network nodes. The transmission offset may correspond to the TA. The transmission offset may be based on the indication of the distance according to Eq. 4, where DUE-BS corresponds to the indication of the distance, and the transmission offset corresponds to the TA.

The indication of the distance between the serving network node and the wireless device may be based on an indication of a position of the serving network node and an indication of a position of the wireless device. The wireless device may determine the indication of its position in the same way as described above, e.g. using OTDOA positioning or OTDOA positioning using compensated RSTD'. The wireless device may determine the indication of its position using at least three RSTD's. The wireless device may determine the indication of its position by receiving (301) the first reference signal at the first reception time from the first network node, receiving (301) the second reference signal at the second reception time from the second network node, wherein the indication of the position of the wireless device may be based on the first representation of the difference between the first reception time and the second reception time. The first representation may further be based on the first indication of the first reference time associated with the first network node and the second indication of the second reference time associated with the second network node. The first representation may correspond to RSTD'.

The first indication of the first reference time may be received (302) from the first network node in a system information message, and the first indication of the first reference time may indicate a timing of a frame structure of the first network node. The second indication of the second reference time may be received (302) from the second network node in a system information message, and the second indication of the second reference time may indicate a timing of a frame structure of the second network node. The first and second indication of the first and second reference time may be defined as described above.

In the same way as described above, the indication of the position may be based on at least the first, second, and third representation. The indication of the position may be based on further representation. Using three representations may enable the wireless device to determine the indication of its position in a two dimensional (x,y) positioning system. Using further representations may enable the wireless device to determine the indication of its position in a three dimensional positioning system (x,y,z), where the third dimension may correspond to the height. The wireless device may determine the indication of the position autonomously based on the received reference signals and the indications of reference times. The wireless device may determine the indication of the position autonomously based on the received reference signals, the indications of reference times, and the indications of positions of the network nodes.

The wireless device may alternatively or additionally use other known methods to determine the indication of its position and/or the indication of the distance. The indication of the distance and or the indication of the position of the wireless device may e.g. be determined based on a Global Navigation Satellite System (GNSS), a round-trip-time (RTT) measurement, received from the serving network node, angle of arrival (AOA) measurements, time of arrival (TOA) measurements, received signal strength (RSS) measurements etc. The indication of the position and/or the indication of the distance may be based on a combination of one or more positioning methods, including e.g. positioning based on the first representation or e.g. OTDOA using the compensated RSTD'. The wireless device may receive the indication of its position from the serving network node. The wireless device may receive the indication of its position in response to the wireless device transmitting a report. The report may be based on the first representation of the difference between the first reception time and the second reception time. The report may correspond to the compensated RSTD'. The report may also correspond to RSTD. The network node may derive the compensated RSTD' based on the reported RSTD, and determine the indication of the position of the wireless device based on the compensated RSTD'.

The wireless device may further receive (303) the indication of the position of the serving network node. The indication of the position of the serving network node may be broadcasted or unicasted from the serving network node or another network node. The indication of the position of the serving network node may be transmitted using e.g. a downlink control message or a system information message. The indication of the position of the serving network node may be transmitted using e.g. an RRC message, a MAC CE, an information element, a DCI message, NAS message etc. The indication of the position of the serving network node may be preconfigured at the wireless device and may be obtained by reading from an internal memory of the wireless device. The indication of the position of the wireless device may be preconfigured at the wireless device and may be obtained by reading from an internal memory of the wireless device, this may be applicable when the wireless device is a stationary wireless device.

The transmission offset may be an offset of an uplink transmission relative to a downlink transmission. The transmission offset may be determined autonomously by the wireless device. The wireless device may use the transmission offset to transmit its uplink transmission earlier in relation to the received downlink, such that the transmission offset may account for the time of flight of the transmission between the serving network node and the wireless device. Different transmission offsets may be used by different wireless devices at different positions to ensure that their transmissions reach the serving network node at the same time. The same time may here correspond to being received with an offset which is within the size of a predefined guard period. The transmission offset may correspond to TA. The transmission offset may be estimated using Eq. 4.

The transmission offset may be estimated by the wireless device before accessing the network of the serving network node. The transmission offset may be estimated by the wireless device while being accessed to the network of the serving network node. This may be done by determining the indication of the distance between the serving network node and the wireless device and accounting for the speed of light (C) to determine the time of flight of an uplink transmission, e.g. as in Eq. 4. The indication of the distance may indicate the distance between the serving network node and the wireless device. The indication of the distance may indicate an absolute distance between the serving network node and the wireless device, e.g. measured as a length between the geographical position of the serving network node and the geographical position of the wireless device. The indication of the distance may indicate a relative distance between the serving network node and the wireless device, e.g. the distance the transmission travels between the serving network node and the wireless device, which may or may not correspond to a straight line. The indication of the distance may indicate a time, where the time may relate to the distance a signal travelling at the speed of light would travel during that time.

The communication signaling may be a random access message. The transmission offset may be determined before accessing the network. The wireless device may use the transmission offset when accessing the network, using e.g. the random access message. The random access message may be a random access preamble. The random access message may be a PRACH preamble.

The communication signaling may be data. The data may be a small data transmission. The communication signaling may correspond to a transmission of data without network access. The transmission offset may be determined before transmitting the data. This may enable the wireless device to use the transmission offset when transmitting the data. The data may be part of a random access message or transmitted independently. The data may be at least part of e.g. an Early Data Transmission (EDT), mobile terminated data, a 2-step random access channel, grant-free transmission, preconfigured uplink resources, or Non-Orthogonal Multiple Access (NOMA) transmission. The transmission offset may be determined after accessing the network, e.g. to update a current transmission offset (e.g. a current TA) with an updated transmission offset (e.g. an updated TA).

The serving network node may be the first network node, the second network node, the third network node, or another network node.

In another example, there is disclosed a method of operating a wireless device in a wireless communication network, the method may comprise receiving the first reference signal at the first reception time from the first network node, receiving the second reference signal at the second reception time from the second network node; and determining the indication of the position of the wireless device, wherein the indication of the position may be based on the first representation of the difference between the first reception time and the second reception time, and wherein the first representation may further be based on the first indication of the first reference time associated with the first network node. The indication of the position may be determined is the same way as described above.

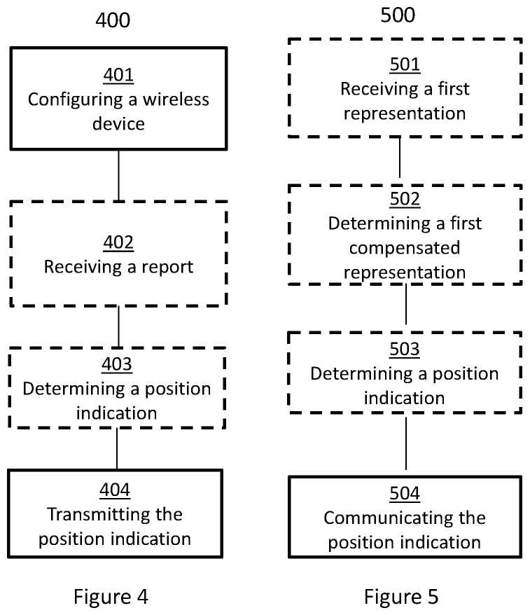

FIG. 4 is a flowchart illustrating a method (400) of operating a serving network node in a wireless communication system. The method (400) may comprise configuring (401) a wireless device to transmit a report, wherein the report may be based on a first indication of a first reference time, wherein the first indication of the first reference time may be associated with a first network node. The method (400) may further comprise receiving (402) the report from the wireless device, wherein the report is based on a first representation of a difference between a first reception time and a second reception time, wherein the first reception time may be associated with a first reference signal transmitted by the first network node to the wireless device, and the second reception time may be associated with a second reference signal transmitted by a second network node to the wireless device, and wherein the first representation may further be based on the first indication of the first reference time.

The configuration may configure the wireless device that the report should be based on the first indication of the first reference time as described above in relation to any of the methods (200, 300) of operating the wireless device. The configuration may be done in response to a capability message transmitted by the wireless device to the serving network node, said capability message may inform the serving network node that the wireless device is capable of transmitting the report based on the first indication of the first reference time.

The first and second reception time may relate to the time of receiving a first and second reference signal at the wireless device. The first and second reference signal may be transmitted by the first and second network node as described above in relation to any of the methods (200, 300) of operating the wireless device.

The first indication of the first reference time may indicate the timing of the frame structure of the first network node as described above in relation to any of the methods (200, 300) of operating the wireless device.

The first representation may further be based on the second representation of the difference between the first indication of the first reference time and the second indication of the second reference time associated with a second network node as described above in relation to any of the methods (200, 300) of operating the wireless device.

The second indication of the second reference time may indicate the timing of the frame structure of the second network node. The first and second indication of the first and second reference time may be indicated in the same way as described above in relation to any of the methods (200, 300) of operating the wireless device.

The report may include the first representation. The report may further include the second, third and/or any further representation. Said representation may be represented in the same way as described above in relation to any of the methods (200, 300) of operating the wireless device. The report may include the RSTD'. The report may include the RSTD.

The method (400) may further involve determining (403) the indication of the position of the wireless device, wherein the indication of the position may be based on the first representation as described above in relation to any of the methods (200, 300) of operating the wireless device. The serving network node may further use the second, third and/or further representation to determine the indication of the position of the wireless device as described above in relation to any of the methods (200, 300) of operating the wireless device. The serving network node may already have access to one or more indications of reference times. The report may include information from which the network node could derive the RSTD' based on the one or more indications of reference times the network node already has access to. The serving network node may at least have access to the indication of its own reference time (e.g. TN_{TX} or TN′_{TX}). The serving network node may use these indications of reference times to compensate the received representations. The indications of reference times may correspond to the reference signal transmission times. The indication of the position estimation is determined in the same way as described above in relation to any of the methods (200, 300) of operating the wireless device. The serving network node may have access to the indication of the position of the first, second, third and/or further network nodes. The indications of the positions of the other network nodes may be preconfigured at the serving network node. The indications of the positions of the other network nodes may be transmitted to the serving network node, e.g. from the other network nodes, or from the wireless device. The serving network node may use the indications of the positions of the first, second, third and/or further network nodes when determining the indication of the position of the wireless device.

The report may additionally or alternatively include the indication of the position of the wireless device, where the indication of the position is determined by the wireless device based on the first representation, as described above in relation to any of the methods (200, 300) of operating the wireless device.

The indication of the position may be determined by another node than the serving network node, e.g. a positioning node. The serving network node may forward information based on the received report and other information (e.g. indications of reference times and/or indications of positions of network nodes) to the other network node, e.g. the positioning network node. The network node may determine the compensated RSTD' based on the received report and transmit the RSTD' to the other network node, e.g. the positioning network node. The network node may receive the indication of the position of the wireless device from the other network node, e.g. the positioning network node.

The method (400) may further involve transmitting (404) the determined indication of the position of the wireless device to the wireless device. The method (400) may involve transmitting the indication of the position of the serving network node and/or other network nodes to the wireless device. The method (400) may further involve transmitting a reference signal from the serving network node. The method (400) may involve transmitting an indication of a reference time of the serving network node and/or further network nodes to the wireless device. The indication of the position of the wireless device and/or the indication of the position of the network node(s) and/or the indications of the reference time of the network node(s) may be transmitted via another network node.

The serving network node may be the first network node, the second network node, the third network node, the positioning network node or another network node.

FIG. 5 is a flowchart illustrating a method (500) of operating a positioning network node in a wireless communication system. The method (500) may comprise receiving (501) a first representation of a difference between a first reception time and a second reception time, wherein the first reception time may be associated with the first reference signal transmitted by the first network node to the wireless device, and the second reception time is associated with the second reference signal transmitted by the second network node and the wireless device. The method (500) may further comprise determining (502) a first compensated representation of the difference, wherein the first compensated representation may be based on the first representation, a first indication of a first reference time associated with the first network node and a second indication of a second reference time associated with the second network node.

The first representation of the difference between the first and second reception time may correspond to the difference between the reception times of the reference signals from the first respective the second network node to the wireless device (e.g. T2_{RX}≠T1_{RX}). The positioning network node may receive the first representation in a report. The report may be received from the wireless device or from another network node. The first representation may correspond to the received reference signal time difference, e.g. the RSTD. The report may include the RSTD. The report may include the RSTD and the first indication of the first reference time (e.g. T1′_{TX}). The report may include the RSTD and the second indication of the second reference time (e.g. T2′_{TX}). The first indication of the first reference time may correspond to the first reference signal transmission time (e.g. T1_{TX}=T1_{TX}). The second indication of the second reference time may correspond to the second reference signal transmission time (e.g. T2_{TX}=T2′_{TX}). The first indication of the first reference time may relate to the first reference signal transmission time and the second indication of the second reference time may relate to the second reference signal transmission time (e.g. T1′_{TX}≠T1′_{TX}≠T2′_{TX}, and (T2_{TX}−T1_{TX})=(T2′_{TX}−T1′_{TX})).

The first compensated representation may be based on the difference between the first and the second indication of the first and second reference time (e.g. T2′_{TX}−T1_{TX}). The first indication of the first reference time may indicate a timing of the frame structure of the first network node and the second indication of the second reference time may indicate the timing of the frame structure of the second network node as described above in relation to any of the methods (200, 300) of operating the wireless device. The first compensated representation may be the difference between the first and second reception time compensated by the difference between the first and second indication of the first and second reference time (e.g. T2_{RX}−T1_{TX} −(T2′_{TX}−T1′_{TX}) or e.g. the RSTD'). This may compensate for the first and second network node not being aligned. The compensation may involve compensating even though the first and second network nodes are aligned, where the first compensated representation may correspond to the first representation.

The method (500) may further involve determining (503) an indication of the position of the wireless device, wherein the indication of the position may be determined based on the first compensated representation. The positioning network node may receive the RSTD report and may compensate using the first and second indication of the first and second reference times, e.g. as described in Eq. 3, to arrive at the compensated RSTD'. The positioning network node may determine the indication of the position of the wireless device based on OTDOA, by using the first compensated representation (e.g. RSTD') instead of the reported first representation (e.g. RSTD). The first compensated representation (e.g. RSTD') may be determined by another network node and communicated to the positioning network node, where the positioning network node may determine the indication of the position of the wireless device based on the received first compensated representation.

The indication of the position of the wireless device may be determined using a second, a third and/or further representations and corresponding second, third, and/or further compensated representations. The second, third and further compensated representations are determined in the same way as the first compensated representation but for other network node pairs. The second, third and/or further compensated representation may be determined by the positioning network node or another network node or the wireless device. The indication of the position of the wireless device may be determined based on indications of positions of the first, second, third and/or further network nodes. The indications of the positions of the network nodes may be received at the positioning network node or preconfigured at the positioning network node.

The indication of the position of the wireless device may be communicated (504) to the wireless device. The indication of the position may be communicated directly to the wireless device or via e.g. the first, second, third, serving or another network node.

The method (500) may further comprise obtaining the first indication of the first reference time and the second indication of the second reference time. Obtaining the first and/or second indication of the first and/or second reference time may comprise receiving the first and/or second indication of the first and/or second reference time from the wireless device. Additionally, or alternatively, obtaining the first indication of the first reference time may comprise receiving the first indication of the first reference time from the first and/or second and/or third and/or serving and/or another network node. Additionally, or alternatively, obtaining the second indication of the second reference time may comprise receiving the second indication of the second reference time from the first and/or second and/or third and/or serving and or another network node. Additionally, or alternatively, obtaining the first and/or second indication of the first and/or second reference time may comprise reading from an internal memory of the positioning network node. Additionally, or alternatively, the first and/or second indication of the first and/or second reference time may be preconfigured at the positioning network node.

The positioning network node may be the first network node, the second network node, the third network node, the serving network node or another network node.

The positioning network node may further implement some or all of the actions as described in relation to the serving network node. And serving network node may further implement some or all of the actions as described in relation to the positioning network node. The positioning network node and the serving network node may be the same network node. The positioning network node may communicate with the serving network node, and the serving network node may communicate with the wireless device using a radio interface. Some parts of the methods (400, 500) may be implemented by the serving network node and some may be implemented by the positioning network node. The positioning network node may receive the first representation in a report, as described in relation to any of the methods (200, 300) of operating the wireless device above, the report may or may not need to be compensated. The compensation may be performed by the wireless device, the serving network node or the positioning network node. If the serving network node receives the first representation, it may forward first representation to the positioning network node as it is received (e.g. RSTD or e.g. (T1_{RX}, T2_{RX}, T1′_{TX}) or e.g. (T2_{RX}−T1_{RX}, T1′_{TX}) or e.g. (T2_{RX}−T1_{RX}, T2′_{RX}−T1′_{TX}), or e.g. RSTD'). The serving network node may alternatively or additionally add information such as e.g. indications of network node positions or indications of reference times (e.g. Position 1, Position 2, . . . , Position N, T1′_{RX}, T2′_{RX}, . . . , TN′_{TX}, (T2′_{RX}−T1′_{RX}) etc.). The serving network node may compensate the received first representation before forwarding (e.g. the RSTD').

A wireless device configured for operation in a radio access network is disclosed. The wireless device may be configured to perform any of the methods (200, 300) of operating the wireless device described above. The wireless device may be implemented as a user equipment or a terminal. The wireless device may comprise, and/or be implemented as, and/or be adapted to utilize, processing circuitry and/or radio front-end circuitry, in particular a transceiver and/or transmitter and/or receiver, for receiving the reference signals and transmitting the report and/or signaling. The wireless device may be configured to perform any of the methods (200, 300) of operating the wireless device as described above. The processing circuitry may be configured to perform any of the methods (200, 300) of operating the wireless device as described above.

A network node configured for operation in a radio access network is disclosed. The network node may be configured to perform any of the methods (400, 500) of operating the positioning network node and/or the serving network node described above. The network node may comprise, and/or be adapted to utilize, processing circuitry and/or radio front-end circuitry, in particular a transceiver and/or transmitter and/or receiver, for communicating, in particular for receiving the report and/or receiving the first representation. The network node may be configured to perform the method (400) of operating the serving network node as described above. The processing circuitry may be configured to perform the method (400) of operating the serving network node as described above. The network node may be configured to perform the method (500) of operating the positioning network node as described above. The processing circuitry may be configured to perform the method (500) of operating the positioning network node as described above.

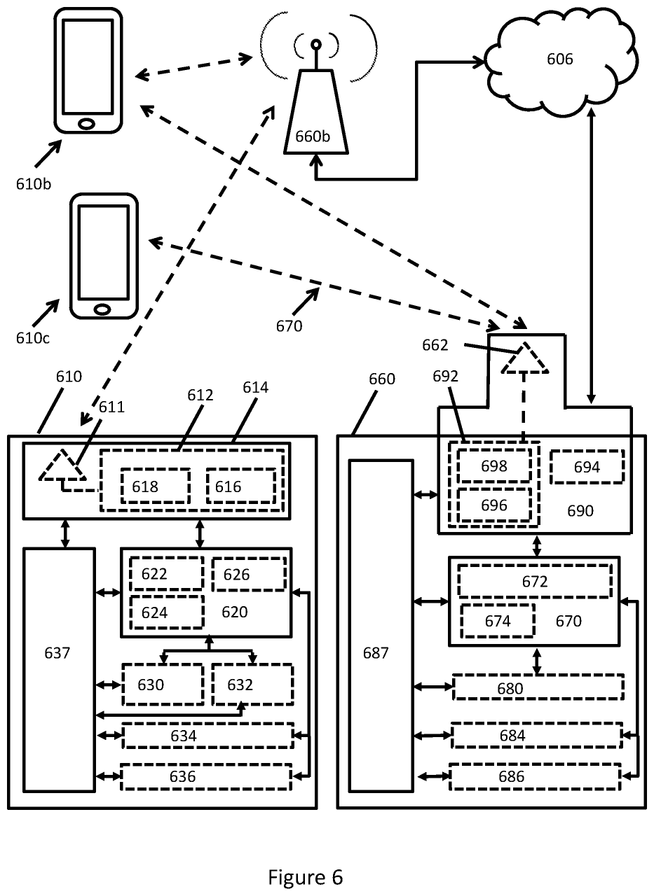

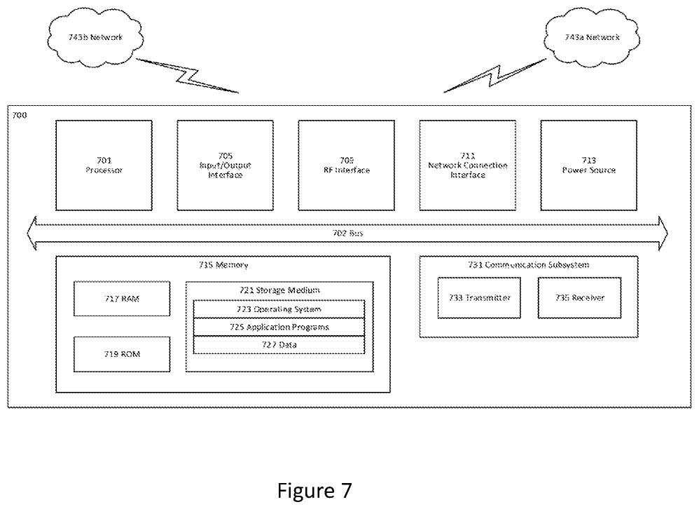

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and wireless devices (WDs) 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and an RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signaling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips.

In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 700 may be any UE identified by the 3rd Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

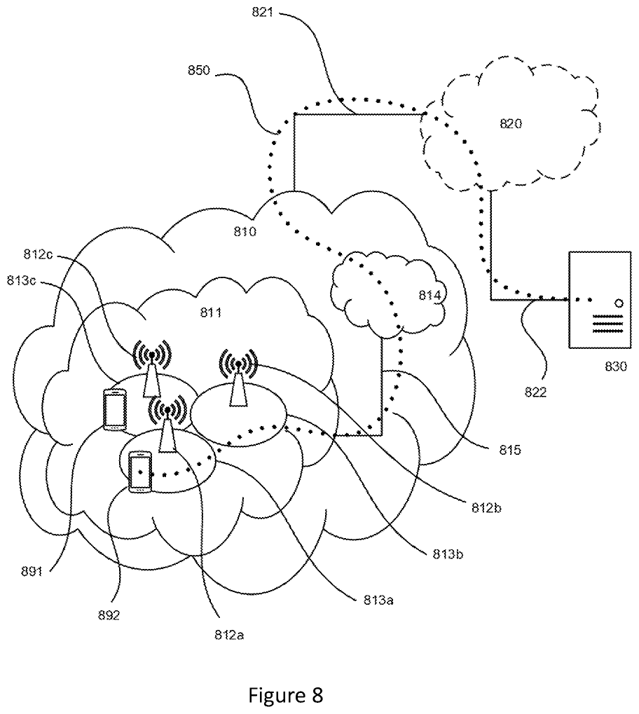

With reference to FIG. 8, in accordance with an embodiment, a communication system includes telecommunication network 810, such as a 3GPP-type cellular network, which comprises access network 811, such as a radio access network, and core network 814. Access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to core network 814 over a wired or wireless connection 815. A first UE 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider, or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 8 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891. Similarly, base station 812 need not be aware of the future routing of an outgoing uplink communication originating from the UE 891 towards the host computer 830.

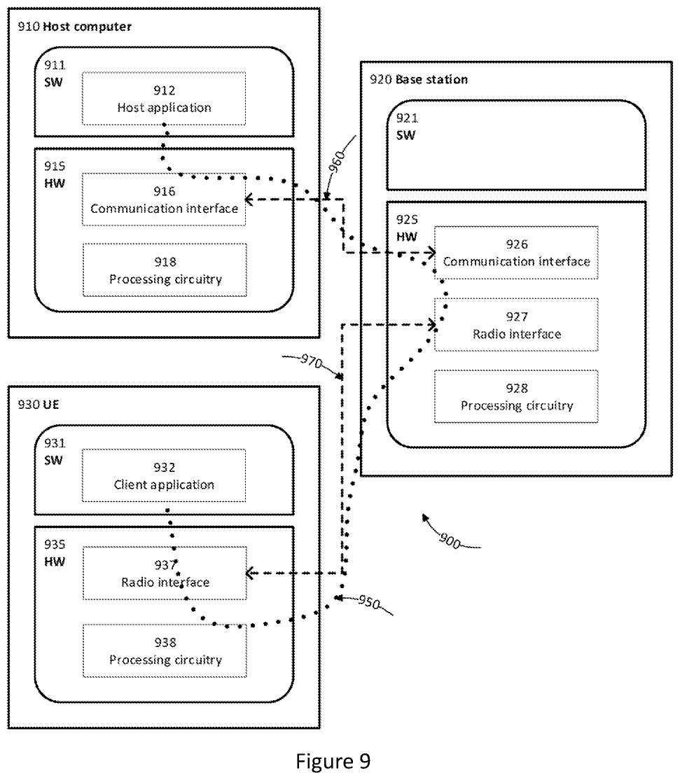

Example implementations, in accordance with an embodiment, of the UE, base station and host computer discussed in the preceding paragraphs will now be described with reference to FIG. 9. In communication system 900, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with UE 930 located in a coverage area (not shown in FIG. 9) served by base station 920. Communication interface 926 may be configured to facilitate connection 960 to host computer 910. Connection 960 may be direct or it may pass through a core network (not shown in FIG. 9) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. Its hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 9 may be similar or identical to host computer 830, one of base stations 812a, 812b, 812c and one of UEs 891, 892 of FIG. 8, respectively. This is to say, the inner workings of these entities may be as shown in FIG. 9 and independently, the surrounding network topology may be that of FIG. 8.

In FIG. 9, OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment. More precisely, the teachings of these embodiments may allow positioning of the UE and reduce the control signaling overhead and thereby provide benefits such as more accurate positioning and reduced user waiting time.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above, or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

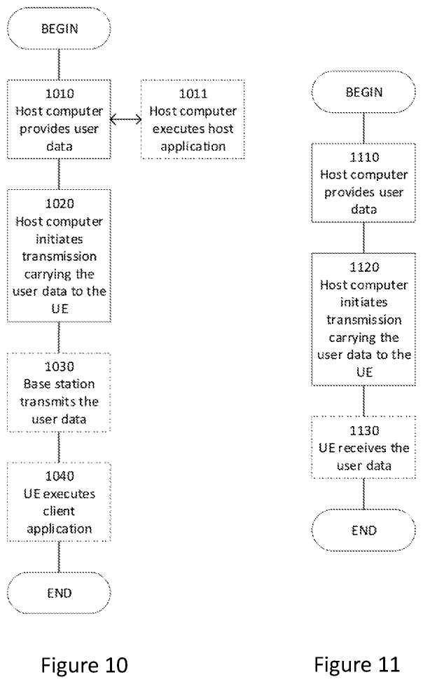

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

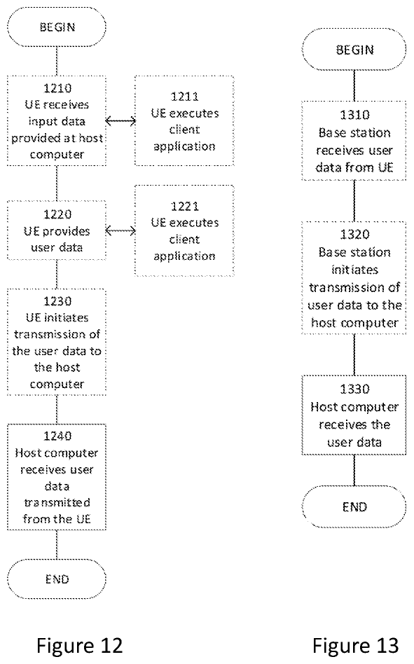

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

### Numbered Embodiments

1. A method (200) of operating a wireless device (610) in a wireless communication network, the method comprising:
   receiving (201) a first reference signal at a first reception time from a first network node (660a);
   receiving (201) a second reference signal at a second reception time from a second network node (660b); and
   transmitting (204), to a serving network node (660), a report, wherein the report is based on a first representation of a difference between the first reception time and the second reception time, and wherein the first representation is further based on a first indication of a first reference time associated with the first network node (660a).
2. The method of embodiment 1, wherein the first indication of the first reference time is received (202) from the first network node (660a) in a system information message, and wherein the first indication of the first reference time indicates a timing of a frame structure of the first network node (660a).
3. The method of any of embodiments 1-2, wherein the first representation is further based on a second representation of a difference between the first indication of the first reference time and a second indication of a second reference time associated with a second network node (660b).
4. The method of embodiment 3, wherein the second indication of the second reference time is received (202) from the second network node (660b) in a system information message, and wherein the second indication of the second reference time indicates a timing of a frame structure of the second network node (660b).
5. The method of any of embodiments 1-4, wherein the report includes the first representation.
6. The method of any of embodiments 1-5, wherein the method further involves determining (203) an indication of a position of the wireless device (610), wherein the indication of the position is determined based on the first representation.
7. The method of embodiment 6, wherein the report includes the indication of the position of the wireless device (610).
8. The method of any of embodiments 1-7, wherein the serving network node (660) is the first network node (660a), the second network node (660b) or another network node.
9. A method (300) of operating a wireless device (610) in a wireless communication network, the method comprising:
   transmitting (304) communication signaling to a serving network node (660) using a transmission offset, wherein the transmission offset is based on an indication of a distance between the serving network node (660) and the wireless device (610).
10. The method of embodiment 9, wherein the indication of the distance between the serving network node (660) and the wireless device (610) is based on an indication of a position of the serving network node (660) and an indication of a position of the wireless device (610).
11. The method of embodiment 10, wherein the method further comprising:
   receiving (301) a first reference signal at a first reception time from a first network node (660a);
   receiving (301) a second reference signal at a second reception time from a second network node (660b);
   wherein the indication of the position of the wireless device (610) is based on a first representation of a difference between the first reception time and the second reception time, and wherein the first representation is further based on a first indication of a first reference time associated with the first network node (660a) and a second indication of a second reference time associated with the second network node (660b).
12. The method of embodiment 11, wherein the first indication of the first reference time is received (302) from the first network node (660a) in a system information message, and wherein the first indication of the first reference time indicates a timing of a frame structure of the first network node (660a), and wherein the second indication of the second reference time is received (302) from the second network node (660b) in a system information message, and wherein the second indication of the second reference time indicates a timing of a frame structure of the first network node (660a).
13. The method of embodiment 10, wherein the indication of the position of the wireless device (610) is determined based on a Global Navigation Satellite System (GNSS) or received from the serving network node (660).
14. The method of any of embodiments 10-13, wherein the indication of the position of the serving network node (660) is received (303) from the serving network node (660).
15. The method of any of embodiments 9-14, transmission offset is an offset of an uplink frame structure relative to a downlink frame structure.
16. The method of any of embodiments 1-13, wherein the communication signaling is a random access message or data.
17. A method of operating a wireless device (610) in a wireless communication network, the method comprising:
   receiving (202) a first reference signal at a first reception time from a first network node (660a);
   receiving (202) a second reference signal at a second reception time from a second network node (660b); and
   determining (203) an indication of a position of the wireless device (610), wherein the indication of the position is based on a first representation of a difference between the first reception time and the second reception time, and wherein the first representation is further based on a first indication of a first reference time associated with the first network node (660a).
18. A method (400) of operating a serving network node (660) in a wireless communication network, the method comprising:
   configuring (401) a wireless device (610) to transmit a report, wherein the report is based on an indication of a first reference time, wherein the first indication of the first reference time is associated with a first network node (660a); and
   receiving (402) the report from the wireless device (610), wherein the report is based on a first representation of a difference between a first reception time and a second reception time,
   wherein the first reception time is associated with a first reference signal transmitted by the first network node (660a) to the wireless device (610), and the second reception time is associated with a second reference signal transmitted by a second network node (660b) to the wireless device (610), and
   wherein the first representation is further based on the first indication of the first reference time.
19. The method of embodiment 18, wherein the first indication of the first reference time indicates a timing of a frame structure of the first network node (660a).
20. The method of any of embodiments 18-19, wherein the first representation is further based on a second representation of a difference between the first indication of the first reference time and a second indication of a second reference time associated with a second network node (660b).
21. The method of embodiment 20, wherein the second indication of the second reference time indicates a timing of a frame structure of the second network node (660b).
22. The method of any of embodiments 18-21, wherein the report includes the first representation.
23. The method of any of embodiments 18-22, wherein the method further involves determining (403) an indication of a position of the wireless device (610), wherein the indication of the position is determined based on the first representation.
24. The method of any of embodiments 18-22, wherein the report includes the indication of the position of the wireless device (610), wherein the indication of the position is determined by the wireless device (610) based on the first representation.
25. The method of any of embodiment 18-24, wherein the serving network node (660) is the first network node (660a), the second network node (660b) or another network node.
26. A method (500) of operating a positioning network node (660) in a wireless communication network, the method comprising:
   receiving (501) a first representation of a difference between a first reception time and a second reception time, wherein the first reception time is associated with a first reference signal transmitted by a first network node (660a) to a wireless device (610), and the second reception time is associated with a second reference signal transmitted by a second network node (660b) and the wireless device (610); and
   determining (502) a first compensated representation of the difference, wherein the first compensated representation is based on the first representation, a first indication of a first reference time associated with the first network node (660a) and a second indication of a second reference time associated with the second network node (660b).
27. The method of embodiment 26, wherein the first compensated representation is based on a difference between the first indication of the first reference time and the second indication of the second reference time.
28. The method of any of embodiments 26-27, wherein the first indication of the first reference time indicates a timing of a frame structure of the first network node (660a) and the second indication of the second reference time indicates a timing of a frame structure of the second network node (660b).
29. The method of any of any of embodiments 26-28, wherein the method further comprising:
   determining (503) an indication of a position of the wireless device (610), wherein the indication of the position is determined based on the first compensated representation.
30. The method of any of embodiments 26-29, wherein the method further involves obtaining the first indication of the first reference time and the second indication of the second reference time, wherein the first and/or second indication of the first and/or second reference time is obtained by one or more of:
   receiving the first and/or second indication of the first and/or second reference time from the wireless device (610);
   receiving the first indication of the first reference time from the first or second network node (660b);
   receiving the second indication of the second reference time from the first or second network node (660b); and
   reading the first and/or second indication of the first and/or second reference time from an internal memory of the positioning network node (660).
31. The method of any of embodiments 26-30, wherein the positioning network node (660) is the first network node (660a), a second network node (660b), or another network node. 32. A wireless device (610) configured for operation in a radio access network, the wireless device (610) being configured to perform the method according to any of embodiments 1-17 33. A wireless device (610) configured for operation in a radio access network, the wireless device (610) comprising:
   processing circuitry configured to perform any of the actions of any of embodiments 1-17.
34. A wireless device (610) configured for operation in a radio access network, the wireless device (610) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the actions of any of embodiments 1-17;
   an input interface connected to the processing circuitry and configured to allow input of information into the UE to be processed by the processing circuitry;
   an output interface connected to the processing circuitry and configured to output information from the UE that has been processed by the processing circuitry; and a battery connected to the processing circuitry and configured to supply power to the UE.
35. A network node configured for operation in a radio access network, the network node being configured to perform the method according to any of embodiments 18-31.
36. A network node configured for operation in a radio access network, the network node comprising:
   processing circuitry configured to perform any of the actions of any embodiments 18-31.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
133 RTT CDMA2000 1x Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
MTC Machine Type Communication
cMTC critical MTC
eMTC enhanced MTC
mMTC massive MTC
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TA Timing Advance
TDD Time Division Duplex
TDOA Time Difference of Arrival
TOA Time of Arrival
TOF Time of Flight
TSN Time Sensitive Networking
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1-45. (canceled)

46. A method of operating a wireless device in a wireless communication network, the method comprising:
receiving a first reference signal at a first reception time from a first network node;
receiving a second reference signal at a second reception time from a second network node;
receiving a first indication of a first reference time associated with the first network node, wherein the first indication of the first reference time indicates a timing of a frame structure of the first network node; and
receiving a second indication of a second reference time associated with the second network node, wherein the second indication of the second reference time indicates a timing of a frame structure of the second network node,
wherein the method further comprises:
transmitting a report to a serving network node, wherein the report is based on a difference between the first reception time and the second reception time compensated by a difference between the first indication of the first reference time and the second indication of the second reference time; or
transmitting communication signaling to a serving network node using a transmission offset, wherein the transmission offset is based on an indication of a distance between the serving network node and the wireless device, wherein the indication of the distance between the serving network node and the wireless device is based on an indication of a position of the serving network node and an indication of a position of the wireless device, wherein the indication of the position of the wireless device is based on a difference between the first reception time and the second reception time compensated by a difference between the first indication of the first reference time and the second indication of the second reference time; or
determining an indication of a position of the wireless device, wherein the indication of the position of the wireless device is based on a difference between the first reception time and the second reception time compensated by a difference between the first indication of the first reference time and the second indication of the second reference time.

47. The method of claim 46, wherein the first indication of the first reference time is received from the first network node and the second indication of the second reference time is received from the second network node.

48. The method of claim 46, wherein the method comprises determining an indication of a position of the wireless device, wherein the indication of the position of the wireless device is determined based on a difference between the first reception time and the second reception time compensated by a difference between the first indication of the first reference time and the second indication of the second reference time, and wherein the report includes the indication of the position of the wireless device.

49. The method of claim 48, wherein the method further comprises receiving a third reference signal at a third reception time from a third network node, wherein the indication of the position of the wireless device is determined further based on:
the third reception time;
a third indication of a third reference time associated with the third network node, wherein the third indication of the third reference time indicates a timing of a frame structure of the third network node; and
indications of positions of the first, second and third network node.

50. The method of claim 46, wherein the report includes the difference between the first reception time and the second reception time compensated by the difference between the first indication of the first reference time and the second indication of the second reference time.

51. The method of claim 46, wherein the serving network node is the first network node, the second network node or another network node.

52. The method of claim 46, wherein the transmission offset is an offset of an uplink frame structure relative to a downlink frame structure.

53. A method of operating a serving network node in a wireless communication network, the method comprising:
configuring a wireless device to transmit a report, wherein the report is based on a first indication of a first reference time and a second indication of a second reference time, wherein the first indication of the first reference time is associated with a first network node, wherein the first indication of the first reference time indicates a timing of a frame structure of the first network node, wherein the second indication of the second reference time is associated with a second network node, wherein the second indication of the second reference time indicates a timing of a frame structure of the second network node,
wherein the method further comprises:
receiving the report from the wireless device, wherein the report is based on a difference between a first reception time and a second reception time compensated by a difference between the first indication of the first reference time and the second indication of the second reference time, wherein the first reception time is associated with a first reference signal transmitted by the first network node to the wireless device, and wherein the second reception time is associated with a second reference signal transmitted by the second network node to the wireless device.

54. The method of claim 53, wherein the first representation is based on a second representation of a difference between the first indication of the first reference time and the second indication of the second reference time.

55. The method of claim 53, wherein the report includes the first representation.

56. The method of claim 53, wherein the method further involves determining an indication of a position of the wireless device, wherein the indication of the position is determined based on the first representation.

57. The method of claim 53, wherein the report includes an indication of a position of the wireless device, wherein the indication of the position is determined by the wireless device based on the first representation.

58. The method of claim 53, wherein the serving network node is the first network node, the second network node or another network node.

59. A wireless device configured for operation in a radio access network, the wireless device comprising processing circuitry configured cause the wireless device to:
receive a first reference signal at a first reception time from a first network node;
receive a second reference signal at a second reception time from a second network node;
receive a first indication of a first reference time associated with the first network node, wherein the first indication of the first reference time indicates a timing of a frame structure of the first network node; and
receive a second indication of a second reference time associated with the second network node, wherein the second indication of the second reference time indicates a timing of a frame structure of the second network node,
wherein the processing circuitry is further configured to cause the wireless device to:
transmit a report to a serving network node, wherein the report is based on a difference between the first reception time and the second reception time compensated by a difference between the first indication of the first reference time and the second indication of the second reference time; or
transmit communication signaling to a serving network node using a transmission offset, wherein the transmission offset is based on an indication of a distance between the serving network node and the wireless device, wherein the indication of the distance between the serving network node and the wireless device is based on an indication of a position of the serving network node and an indication of a position of the wireless device, wherein the indication of the position of the wireless device is based on a difference between the first reception time and the second reception time compensated by a difference between the first indication of the first reference time and the second indication of the second reference time; or
determine an indication of a position of the wireless device, wherein the indication of the position of the wireless device is based on a difference between the first reception time and the second reception time compensated by a difference between the first indication of the first reference time and the second indication of the second reference time.

60. The wireless device of claim 59, wherein the processing circuitry is configured to cause the wireless device to receive the first indication of the first reference time from the first network node and to receive the second indication of the second reference time from the second network node.

61. The wireless device of claim 59, wherein the processing circuitry is configured to cause the wireless device to determine an indication of a position of the wireless device, wherein the indication of the position of the wireless device is determined based on a difference between the first reception time and the second reception time compensated by a difference between the first indication of the first reference time and the second indication of the second reference time, and wherein the report includes the indication of the position of the wireless device.

62. The wireless device of claim 59, wherein the processing circuitry is further configured to cause the wireless device to receive a third reference signal at a third reception time from a third network node, wherein the processing circuitry is configured to cause the wireless device to determine the indication of the position of the wireless device further based on:
the third reception time;
a third indication of a third reference time associated with the third network node, wherein the third indication of the third reference time indicates a timing of a frame structure of the third network node; and
indications of positions of the first, second and third network node.

63. The wireless device of claim 59, wherein the serving network node is the first network node, the second network node or another network node.

64. A network node configured for operation in a radio access network, the network node comprising processing circuitry configured to cause the network node to:
configure a wireless device to transmit a report, wherein the report is based on a first indication of a first reference time and a second indication of a second reference time, wherein the first indication of the first reference time is associated with a first network node, wherein the first indication of the first reference time indicates a timing of a frame structure of the first network node, wherein the second indication of the second reference time is associated with a second network node, wherein the second indication of the second reference time indicates a timing of a frame structure of the second network node,
wherein the processing circuitry is further configured to cause the network node to:
receive the report from the wireless device, wherein the report is based on a difference between a first reception time and a second reception time compensated by a difference between the first indication of the first reference time and the second indication of the second reference time, wherein the first reception time is associated with a first reference signal transmitted by the first network node to the wireless device, and wherein the second reception time is associated with a second reference signal transmitted by the second network node to the wireless device.

65. The network node of claim 64, wherein the serving network node is the first network node, the second network node or another network node.
